(19) United States
(12) Patent Application Publication
(10) Pub. No.: US 2013/0321617 A1
(43) Pub. Date: Dec. 5, 2013

(54) ADAPTIVE FONT SIZE MECHANISM

(71) Applicants: Doron Lehmann, Kfar Vradim (IL); Eyal Nathan, Tel-Aviv (IL); Nimrod Barak, Nes Tziona (IL)

(72) Inventors: Doron Lehmann, Kfar Vradim (IL); Eyal Nathan, Tel-Aviv (IL); Nimrod Barak, Nes Tziona (IL)

(21) Appl. No.: 13/483,647

(22) Filed: May 30, 2012

(51) Int. Cl. G06T 11/00; H04N 7/18

(52) U.S. Cl. 348/135; 345/472; 348/E07.085

(57) ABSTRACT

According to some embodiments, a method and apparatus are provided to determine a distance between a mobile device and a user, and adjust a font size of content displayed on a mobile device display based on the determined distance.

### BACKGROUND

Many users view web pages via a mobile device (e.g., tablet or cellular phone). However, viewing and interacting with a web page displayed on a mobile device can sometimes be difficult because mobile devices have relatively small screens and therefore a font size of data displayed on the screen is relatively small which makes the data hard to read, especially when reading a document or a web page that contains a large amount of text.

A user often has to hold the mobile device close to their face to clearly see the data displayed on the screen or the user may use some form of magnification assistance such as glasses, a pinch to zoom gesture, or a magnifying glass.

### BRIEF DESCRIPTION OF THE DRAWINGS

FIG. 1 illustrates a method according to some embodiments.

FIG. 2 illustrates a user viewing a web page on a mobile device according to some embodiments.

FIG. 3 illustrates a system according to some embodiments.

FIG. 4 illustrates a computing system according to some embodiments.

FIG. 5 is a block diagram of an apparatus according to some embodiments.

FIG. 6 illustrates a portion of a database that might be stored in accordance with some embodiments.

### DETAILED DESCRIPTION

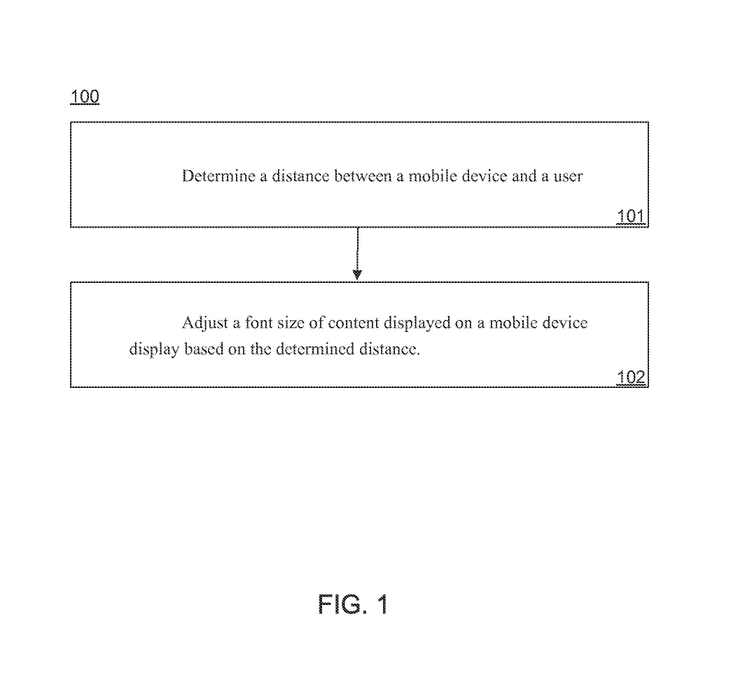

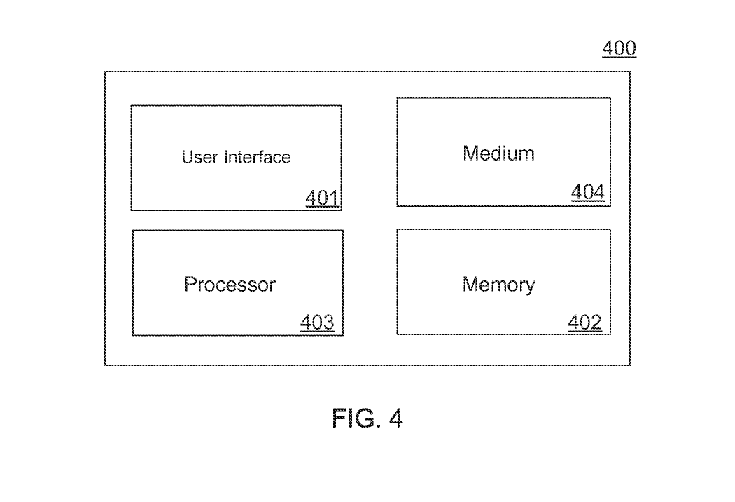

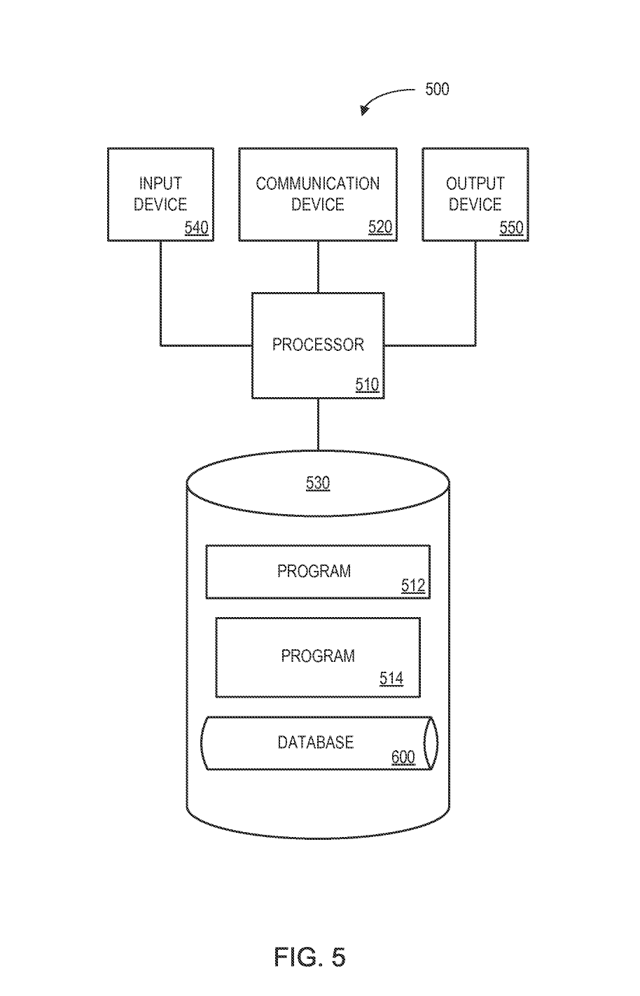

Referring now to FIG. 1, an embodiment of a method 100 is illustrated. The method 100 may be embodied on a non-transitory computer-readable medium. Furthermore, the method 100 may be performed by an apparatus such as, but not limited to, the apparatus of FIG. 4 or FIG. 5. The method 100 may relate to managing font sizes of web pages that are being viewed via a mobile device.

At 101, a distance between a mobile device and a user is determined. The distance may comprise a physical distance between the user and the mobile device. For example, the user may hold the mobile device at a distance away from the user's face and the distance between the mobile device and the user's face may be determined. The distance may be measured in any conventional unit of measurement (e.g., inches, centimeters) and may be measured using a sensor located at the mobile device. In some embodiments, the sensor may comprise a camera, rangefinder, sound propagation sensor, or any other sensor associated with determining a distance.

For illustrative purposes, and to aid in understanding features of the specification, some examples will now be introduced. These examples are not intended to limit the scope of the claims.

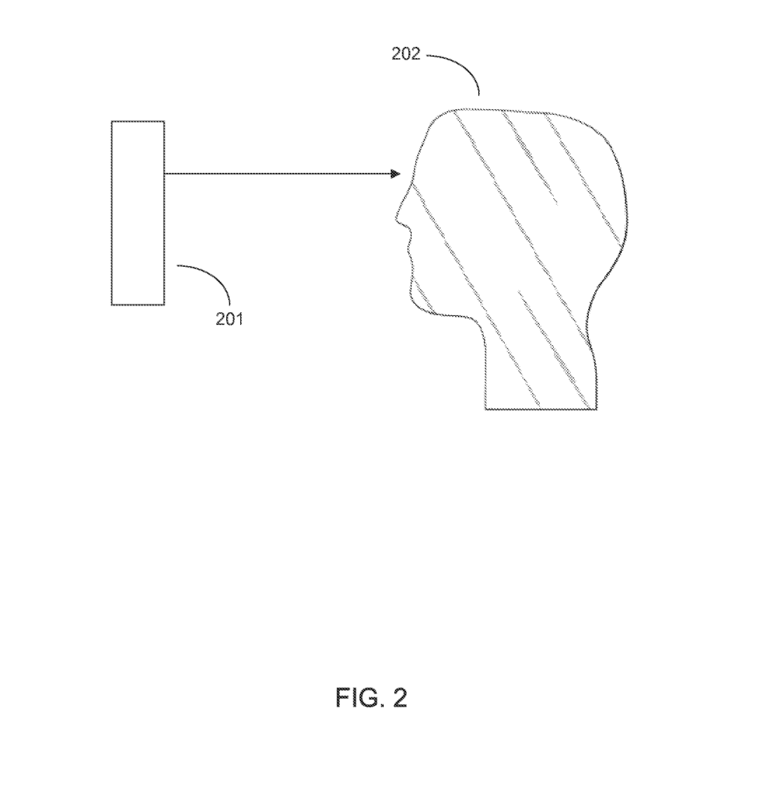

In a first example, a user, such as user 202 of FIG. 2 holds a mobile device 201 at a distance away from his face. The mobile device, using an internal camera, determines a distance between the user 202 and the mobile device 201.

In a second example, a user who normally wears glasses, such as user 202 of FIG. 2 tries to view his mobile device without wearing glasses. The user 202 holds the mobile device 201 at a distance away from his face. The mobile device 201, using an internal camera, determines a distance between the user 202 and the mobile device 201.

Referring back to FIG. 1, at 102, a font size of the content displayed on a mobile device display is adjusted based on the determined distance. Adjusting a font size may comprise increasing or decreasing a size of the font. In some embodiments, adjusting a font size may comprise adjusting a shape of the font based on an eyeglass prescription.

The font size may be adjusted based on a pre-defined set of rules that indicate an optimal font size for each given distance between the mobile device and the user. For example, a first font size may be associated with a first distance between the mobile device and the user, a second font size may be associated with a second distance between the mobile device and the user, a third font size may be associated with a third distance between the mobile device and the user, etc. The font size may steadily increase as a distance from the mobile device to the user increase. However, in other embodiments, the increase may be based on a series of distance plateaus (e.g. ranges of distances) such that a first font size may be associated with a first range of distances between the mobile device and the user (e.g., x inches to y inches, where x and y are real numbers or integers), a second font size may be associated with a second range of distances between the mobile device and the user, a third font size may be associated with a third range of distances between the mobile device and the user, etc. The size of the font may be based on a reference font size at a set distance. For example, a reference font size of 12 at a distance of 3 inches from a user's face may be considered a reference font size. Therefore, font size adjustment may be based on the reference font size (e.g., plus or minus a font size from the reference size).

In another embodiment, adjusting the font size may be further based on an eyeglass prescription of the user. A user may enter his prescription into his mobile device and the mobile phone may use the entered eyeglass prescription to determine a size of the font to display on a screen (i.e. a display) based on the distance between the mobile device and the user. For example, a user may enter in spherical correction values, cylindrical correction values, and axis values associated the user's prescription. In response to receiving the aforementioned values, a system may convert the prescription into a magnification factor that will be used to change a font size such that a font a user sees at a particular distance will be similar to a reference font at a reference distance. The font shape may also be changed by introducing blur or correcting blur to adjust for astigmatism.

In some embodiments, the adjustment to the font size may be determined by the mobile device. In this embodiment, the mobile device may determine the adjustment to font sizes associated with a received web page based at least on a distance from the mobile device to the user. The mobile device may further present an option, such as a soft key, so that the adjustment to font sizes may be based not only on a distance between the mobile device and the user, but also on a previously entered eyeglass prescription. Such an embodiment may facilitate easier viewing of text on a mobile device.

In another embodiment, the distance from the user to the mobile device may be transmitted to the web server and the web server may determine an adjustment to the font size of a web page to be sent to the mobile device. In this embodiment, the mobile device may also present an option, such as a soft key, so that the user's previously entered eyeglass prescription is transmitted to the web server to adjust font sizes based not only on a distance between the mobile device and the user, but also on the previously entered eyeglass prescription. The eyeglass prescription information may have been entered at the mobile device which may then be transmitted to the server to translate the eyeglass prescription into a magnification factor. In some embodiments, using an eyeglass prescription to determine a magnification factor may allow a user who normally wears glasses to be able to more clearly view web pages on a mobile device.

Furthermore, the magnification may also be based on the capability of the device. For example, a web server may query the mobile device to determine a display resolution and the font size may be limited based on what can be displayed on the display of the mobile device. A display resolution may be determined by a media query which returns a screen resolution of the mobile device accessing the web page. The modification of a web page's font size may be associated with a modification of a cascading style sheet (“CSS”).

By modifying a CSS associated with a web page, an application that controls the web page is not affected since the CSS is a layer above the application and the CSS determines what to show or not to show based on data received from the mobile device and in some embodiments, on a role of the user. For example, when the mobile device is moved away from a user's face, only selected information may be enlarged while non-selected material will not be enlarged. The selected information to be enlarged may be based on a user role of the user of the mobile device. Furthermore, selection of the data to be enlarged may be via a CSS.

Continuing with the first example, the mobile device transmits the distance between the mobile device and the user to a web server. The web server, using a lookup table or formula, determines an increase to the font on a currently viewed web page. The webserver, in response to the determination, increases a font size of the currently viewed web page and transmits a web page with the adjusted font size to the mobile device.

Continuing with the second example, the mobile device transmits the distance between the mobile device and the user to a web server. Furthermore, in response to a soft key, or other indicating mechanism being activated, the mobile device transmits an eyeglass prescription (previously entered by the user) to the web server. The web server, using a lookup table or formula, as well as the eyeglass prescription, determines an increase to the font on the currently viewed web page. The webserver, in response to the determination, increases a font size of the currently viewed web page and transmits a web page with the adjusted font size.

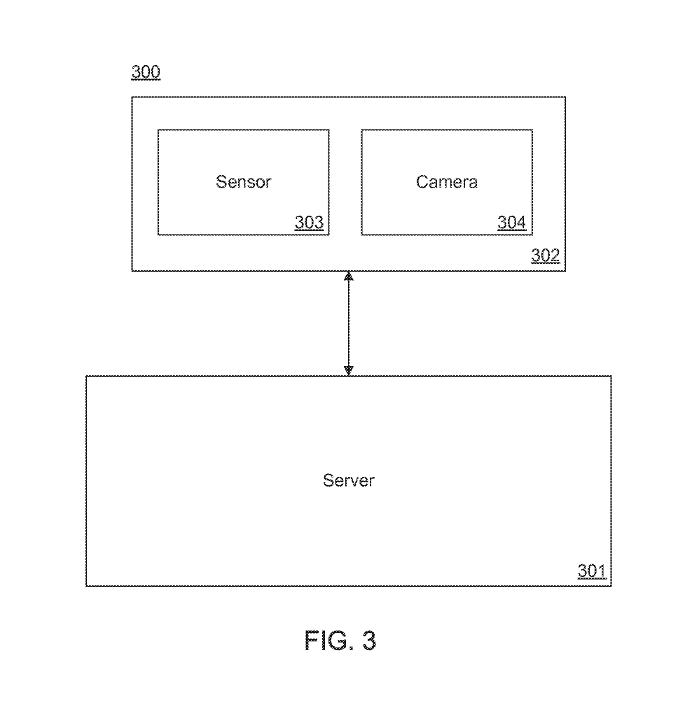

Now referring to FIG. 3, an embodiment of a system 300 is illustrated. The system 300 may comprise a server 301 and a mobile device 302. The server 301 may be described with respect to FIG. 4. The mobile device comprises a sensor 303, a camera 304 and may be further described with respect to FIG. 5. The sensor 303 may comprise a sensor used to determine a distance between the mobile device and a user of the mobile device. The camera 304 may comprise a digital camera. In some embodiments, the camera 304 may determine a distance between the mobile device and a user of the mobile device.

Now referring to FIG. 4, an embodiment of an apparatus 400 is illustrated. The apparatus 400 may comprise a user interface 401, a main memory 402, a processor 403, and a medium 404. According to some embodiments, the apparatus 400 may further comprise a digital display port, such as a port adapted to be coupled to a digital computer monitor, television, portable display screen, or the like.

The user interface 401 may allow users to interact with the apparatus 400 using text commands or with images/ graphical icons. In some embodiments, the user interface may comprise a keyboard, mouse, or associated port related thereto. Furthermore, the user interface 401 may comprise a display or a touch screen.

The main memory 402 may comprise any type of memory for storing data, such as, but not limited to, a Secure Digital (SD) card, a micro SD card, a Single Data Rate Random Access Memory (SDR-RAM), a Double Data Rate Random Access Memory (DDR-RAM), or a Programmable Read Only Memory (PROM). The main memory 402 may comprise a plurality of memory modules.

The processor 403 may include or otherwise be associated with dedicated registers, stacks, queues, etc. that are used to execute program code and/or one or more of these elements may be shared there between. In some embodiments, the processor 403 may comprise an integrated circuit. In some embodiments, the processor 403 may comprise circuitry to perform a method such as, but not limited to, the method described with respect to FIG. 1.

The medium 404 may comprise any computer-readable medium that may store processor-executable instructions to be executed by the processor 403. For example, the medium 404 may comprise a non-transitory tangible medium such as, but is not limited to, a compact disk, a digital video disk, flash memory, optical storage, random access memory, read only memory, or magnetic media.

Now referring to FIG. 5, FIG. 5 is a block diagram overview of an apparatus 500 according to some embodiments. The apparatus 500 may be, for example, associated with a mobile device, such as a phone or tablet. The apparatus 500 comprises a processor 510, such as one or more commercially available Central Processing Units (CPUs) in the form of one-chip microprocessors, coupled to a communication device 520 configured to communicate via a communication network (not shown in FIG. 5). The communication device 520 may be used, for example, as an input path to receive information about user roles. The apparatus 600 further includes an input device 540 (e.g., a touchscreen for navigation of a web page) and an output device 550 (e.g., a touchscreen to display the web page).

The processor 510 communicates with a storage device 530. The storage device 530 may comprise any appropriate information storage device, including combinations of magnetic storage devices (e.g., a hard disk drive), optical storage devices, and/or semiconductor memory devices. The storage device 530 stores a program 512 and/or navigation platform 514 for controlling the processor 510. The processor 510 performs instructions of the programs 512, 514, and thereby operates in accordance with any of the embodiments described herein. For example, the processor 510 may determine a screen resolution of the apparatus 500.

The programs 512, 514 may be stored in a compressed, uncompiled and/or encrypted format. The programs 512, 514 may furthermore include other program elements, such as an operating system, a database management system, and/or device drivers used by the processor 510 to interface with peripheral devices.

As used herein, information may be “received” by or “transmitted” to, for example: (i) the apparatus 500 from another device; or (ii) a software application or module within the apparatus 500 from another software application, module, or any other source.

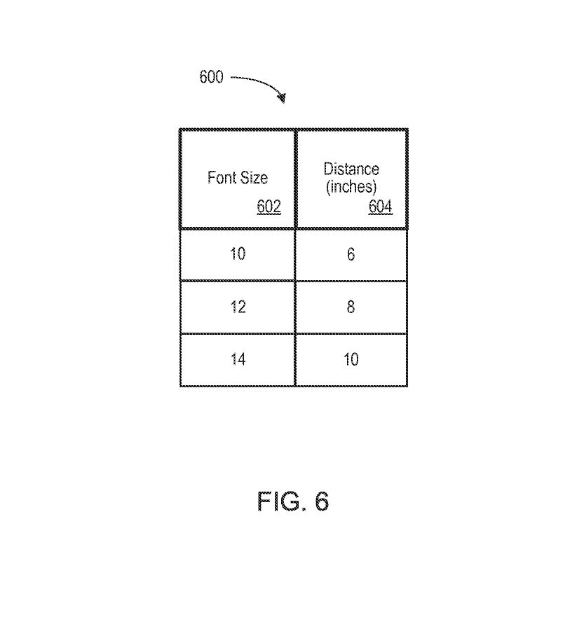

In some embodiments (such as shown in FIG. 5), the storage device 530 stores a database 600 (e.g., including information associated with the mobile device.). An example of a database that may be used in connection with the apparatus 500 will now be described in detail with respect to FIG. 6. Note that the database described herein is only an example, and additional and/or different information may be stored therein. Moreover, various databases might be split or combined in accordance with any of the embodiments described herein.

Referring to FIG. 6, a table is shown that represents the database 600 that may be stored locally at the apparatus 500 according to some embodiments or at a web server, such as apparatus 400, according to other embodiments. The table may include, for example, entries identifying information about font sizes and distances. The table may also define fields 602 and 604 for each of the entries. The fields 602 and 604, may, according to some embodiments, specify: a font size 602 and a distance 604. The information in the database 600 may be created and updated, for example, based on data received from a mobile device.

The following illustrates various additional embodiments and do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Moreover, while embodiments have been illustrated using particular types of tables and databases, embodiments may be implemented in any other of a number of different ways. For example, some embodiments might be associated with publically available information, such as flight or train schedules available via web sites.

Embodiments have been described herein solely for the purpose of illustration. Persons skilled in the art will recognize from this description that embodiments are not limited to those described, but may be practiced with modifications and alterations limited only by the spirit and scope of the appended claims.

What is claimed is:

1. A method comprising:
determining a distance between a mobile device and a user; and
adjusting, via a processor, a font size of content displayed on a mobile device display based on the determined distance.

2. The method of claim 1, wherein adjusting the font size is further based on a pre-defined set of rules associated with an optimal font size for each given distance from the mobile device to a user.

3. The method of claim 1, wherein adjusting the font size is further based on an eyeglass prescription of the user.

4. The method of claim 1, wherein determining a distance between the mobile device and the user is via a camera.

5. The method of claim 1, wherein the adjustment to the font size is determined by the mobile device.

6. The method of claim 1, wherein the adjustment to the font size is determined by a web server.

7. A non-transitory computer-readable medium comprising instructions that when executed by a processor perform a method, the method comprising:
determining a distance between a mobile device and a user; and
adjusting, via a processor, a font size of content displayed on a mobile device display based on the determined distance.

8. The medium of claim 7, wherein adjusting the font size is further based on a pre-defined set of rules associated with an optimal font size for each given distance from the mobile device to a user.

9. The medium of claim 7, wherein adjusting the font size is further based on an eyeglass prescription of the user.

10. The medium of claim 7, wherein determining a distance between the mobile device and the user is via a camera.

11. The medium of claim 7, wherein the adjustment to the font size is determined by the mobile device.

12. The medium of claim 7, wherein the adjustment to the font size is determined by a web server.

13. An apparatus comprising:
a processor;
a non-transitory computer-readable medium comprising instructions that when executed by the processor perform a method, the method comprising:
determining a distance between a mobile device and a user; and
adjusting a font size of content displayed on a mobile device display based on the determined distance.

14. The apparatus of claim 13, wherein adjusting the font size is further based on a pre-defined set of rules associated with an optimal font size for each given distance from the mobile device to a user.

15. The apparatus of claim 13, wherein adjusting the font size is further based on an eyeglass prescription of the user.

16. The apparatus of claim 13, wherein determining a distance between the mobile device and the user is via a camera.

17. The apparatus of claim 13, wherein the adjustment to the font size is determined by the mobile device.

18. The apparatus of claim 13, wherein the adjustment to the font size is determined by a web server.
